(19) United States
(12) Patent Application Publication
(10) Pub. No.: US 2010/0300868 A1
(43) Pub. Date: Dec. 2, 2010

(54) DEVICE FOR PRODUCING DRINKING WATER

(76) Inventor: Bruno Pirone, San Rocco Castagnaretta (Cuneo) (IT)

Correspondence Address: SUGHRUE MION, PLLC, 2100 PENNSYLVANIA AVENUE, N.W., SUITE 800, WASHINGTON, DC, 20037, US

(21) Appl. No.: 12/676,841

(22) PCT Filed: Sep. 4, 2008
(86) PCT No.: PCT/IB08/53578

§ 371 Date: Mar. 5, 2010

(30) Foreign Application Priority Data
Sep. 6, 2007 (IT) TO2007A000626

(51) Int. Cl. C02F 1/04

(52) U.S. Cl. 202/175; 202/232; 202/185.1

(57) ABSTRACT

A device for producing drinking water is described, said device comprising supply means (10, 10a, V1, 11) able to provide a quantity of inlet water; a distillation system (20, 21, 23) able to distil said quantity of inlet water so as to obtain a corresponding quantity of distilled water; a salt supply system (40) able to provide, in the form of a concentrated aqueous solution, at least one reserve supply of salts necessary for obtaining water which may be defined as drinking water; and a mixing system (30) able to receive at least a part of this salt reserve and mix it in a controlled manner with the quantity of distilled water, at the same time aerating the latter, so as to provide drinking water; and a dispensing tap (50) able to dispense this quantity of drinking water.

The present invention relates to a device for producing drinking water.

It is known that even the water supplied by the water mains network may contain undesirable substances such as nitrates, nitrites, heavy metals (lead and the like), traces of pesticides, etc., which, for various reasons, may elude the water monitoring procedures stipulated by law.

On the other hand, it is known to use water filtering or purification systems, such as carbon filters, reverse osmosis and ion exchange filters which may be installed in dwellings and other buildings in order to treat the drinking water and improve its properties.

The known systems, however, have certain drawbacks. For example, active-carbon filters reduce the presence of chlorine, organic substances and pesticides but, apart from not being effective against other substances (nitrates, heavy metals, etc.), may become a breeding ground for a large number of pathogenic bacteria if they are not replaced when saturated, something which can be determined only by means of suitable analyses and cannot be programmed since it also depends on the degree of contamination of the water.

Reverse-osmosis filters retain heavy metals, pathogenic germs and nitrates (but not chlorine and therefore do not eliminate the unpleasant taste associated with the latter), but their fragility is such that the membrane may break (detectable only by means of a specialized installation engineer) and, moreover, they may deprive the water of the salts which are biologically necessary such that it is not suitable for drinking unless remineralized beforehand.

Ion-exchange filters eliminate salts and heavy metals, but not the pathogenic agents (and consequently become breeding grounds for bacteria) nor the substances responsible for unpleasant tastes and smells.

Some studies have shown, moreover, that the use of these known systems is acceptable only for treating water if it is already of good quality.

The object of the present invention is to provide a device for producing drinking water which overcomes the drawbacks of the abovementioned prior art.

This object is achieved according to the invention by a device having the characteristic features defined in claim 1.

Such a device, in contrast to the known systems which are based on filtration for removal of the substances contained in the treated water, uses heat separation which ensures the sterilization and the complete elimination of foreign agents.

Therefore, the device according to the invention may be used not only with mains water, but also with river water, brackish water or even water which is polluted.

Preferred embodiments of the invention are defined in the dependent claims.

Further characteristic features and advantages of the invention will be explained more fully in the following detailed description of an embodiment thereof, provided by way of a non-limiting example, with reference to the accompanying drawings in which:

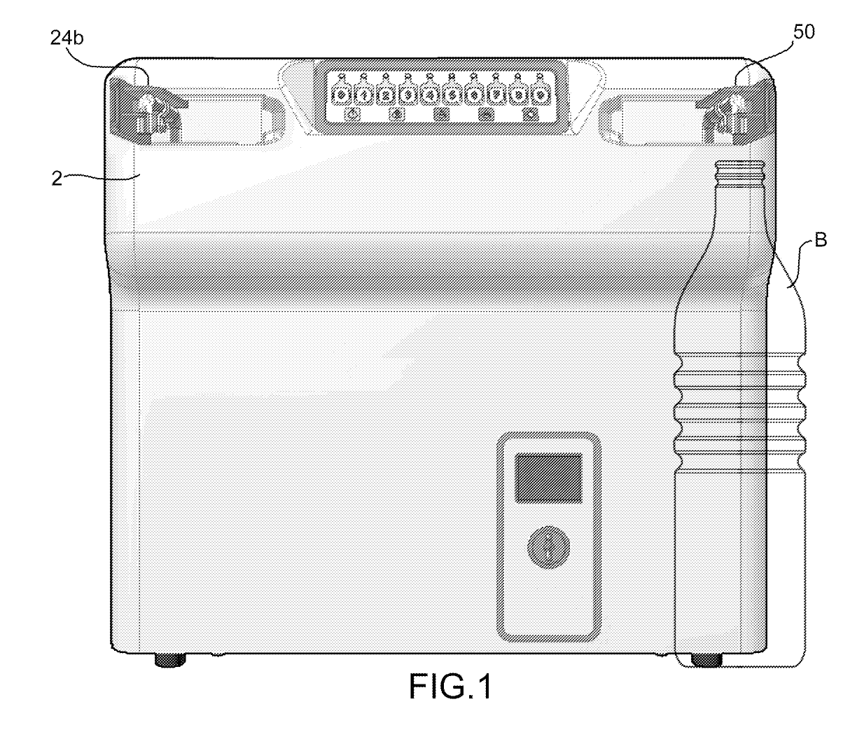

FIG. 1 is a front view of a device for producing drinking water according to the invention;

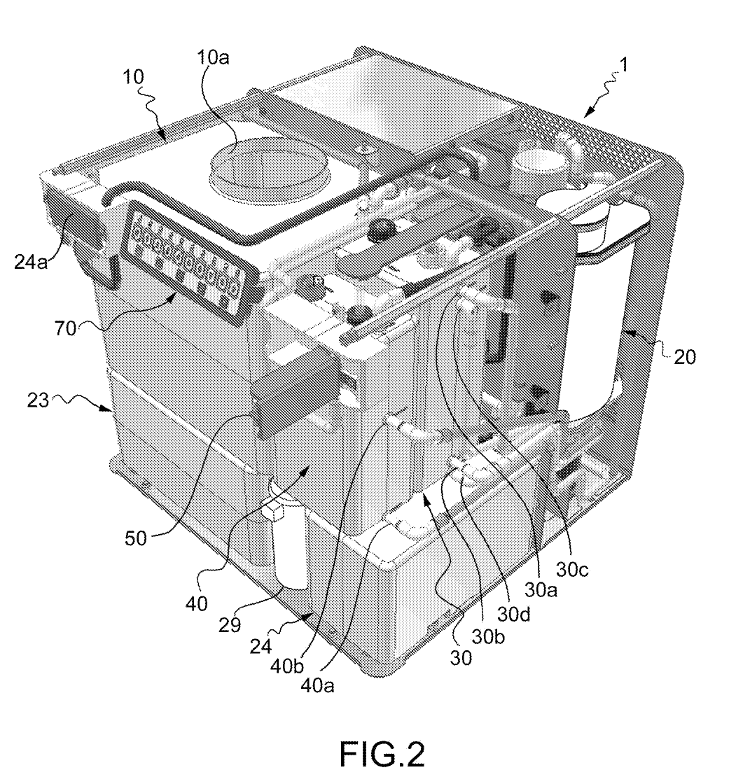

FIG. 2 is a perspective view of the device according to FIG. 1, with the cover removed;

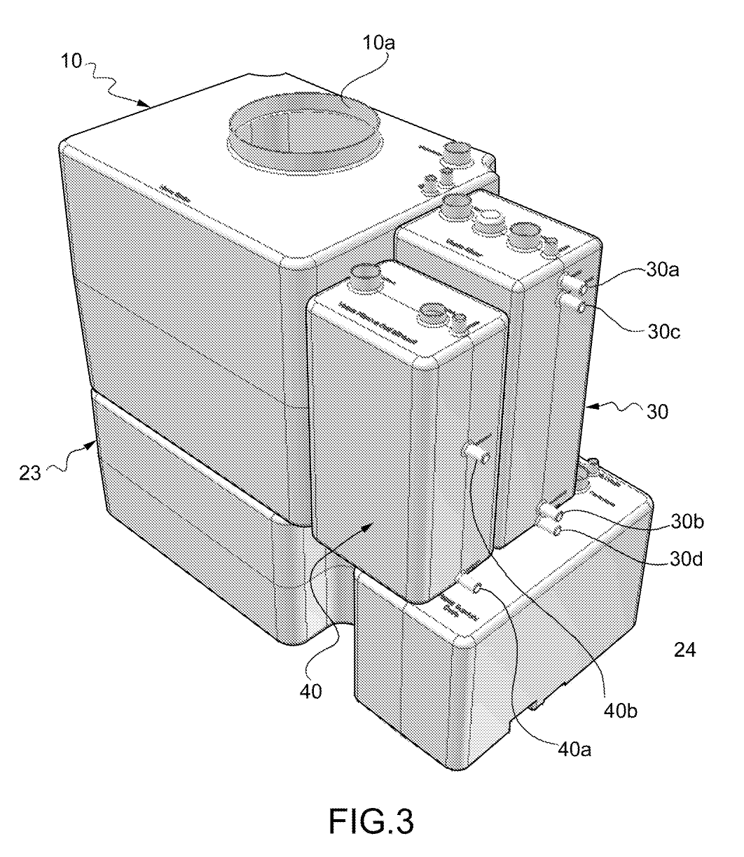

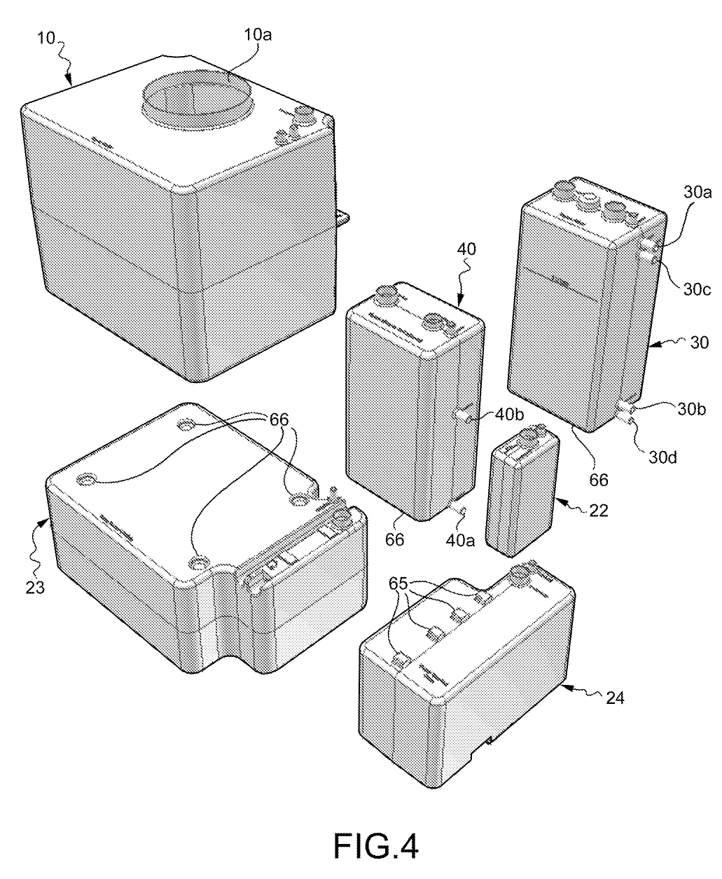

FIGS. 3 and 4 are perspective views of a set of reservoirs of the device according to FIG. 1, in the assembled condition and disassembled condition, respectively;

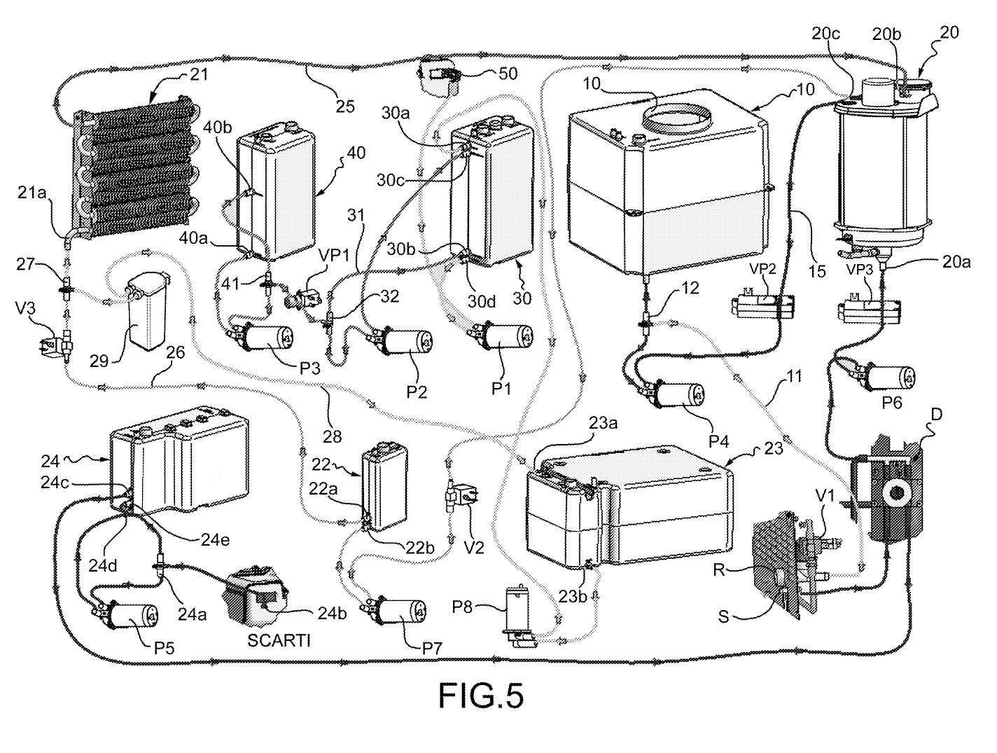

FIG. 5 is a hydraulic connection diagram of the device according to FIG. 1;

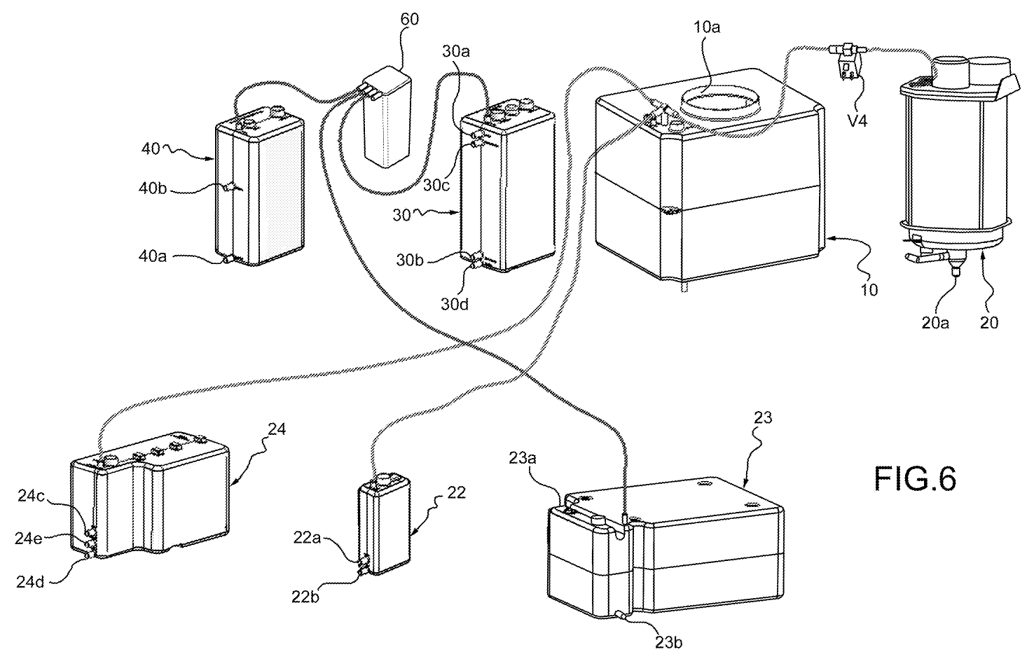

FIG. 6 is a diagram showing the breather line layout of the device according to FIG. 1;

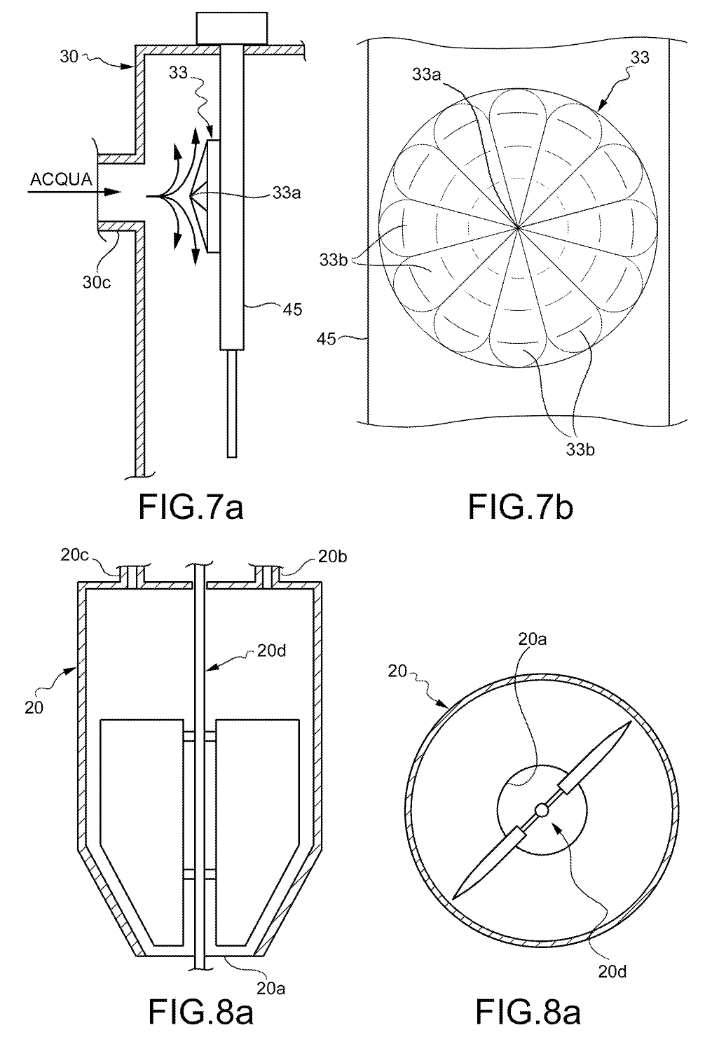

FIGS. 7a and 7b are a schematic cross-sectional view and a schematic front view, respectively, of a detail of the device according to the invention; and

FIGS. 8a and 8b are a schematic longitudinally sectioned view and a schematic transverse view, respectively, of another detail of the device according to the invention.

With reference to FIGS. 1 and 2 a device for producing drinking water according to the invention comprises a housing 1 with a removable cover 2 containing the apparatus which make up the device. FIG. 2 shows the device without the cover 2 so that these apparatus are partly visible.

With reference to FIGS. 2 and 5, the device comprises supply means able to provide a quantity of inlet water to be treated. In the embodiment shown, the supply means comprise a filling reservoir or tank 10 which is connected via a supply valve V1, a flexible pipe 11 and a T-union 12 to a filling inlet of an external water supply network denoted by R. The valve V1 is operated by a control unit (not shown) which generally manages the apparatus of the device and opens and closes the valve V1 when it detects that the minimum and maximum water levels inside the tank 10 are reached. The tank 10 also has at the top a filling opening 10a for manually filling it from above.

Via the T-union 12 the filling tank 10 is also connected to the intake of the pump P4, the delivery of which is connected to a flexible pipe 15 on which a pipe-clamp valve VP2 is mounted.

The flexible pipe 15 is then connected to means for treating the quantity of inlet water, designed to produce a corresponding quantity of drinking water.

These treatment means comprise distillation means able to distil the quantity of inlet water so as to obtain a corresponding quantity of distilled water; salt supply means able to provide, in the form of concentrated solution, at least one reserve supply of salts necessary for obtaining water which may be defined as drinking water; and mixing means able to receive at least a part of the salt reserve and mix it in a controlled manner with the quantity of distilled water, at the same time aerating the latter, so as to provide the drinking water.

The distillation means essentially comprise a boiler 20, a condenser 21, a top fraction discharge reservoir or tank 22, a distillate reserve tank 23 and a bottom fraction discharge tank 24.

The flexible pipe 15 leading from the pump P4 is connected to the inlet of the boiler 20 which is able to boil the water supplied to it. As can be seen in FIGS. 8a and 8b, the boiler 20 is preferably provided, internally, with a vane-type scraper apparatus 20d which is designed to scrape the inner surfaces of the boiler during boiling of the water so as to remove the lime scale and any other residue deposited on these surfaces. The scraper apparatus comprises a shaft which is rotatable inside the boiler 20 and on which a plurality of vanes are mounted. These vanes may have any profile, for example a flat profile such as that shown in FIG. 8b, or a curved profile. The boiler 20 has a discharge outlet 20a for elimination of the distillation residue, which is connected, via a pipe-clamp valve VP3 and a pump P6, to a switching unit D. The switching unit D then connects the discharge outlet 20a of the boiler 20, selectively, to a discharge outlet S of a sewerage system or to an inlet 24c of the bottom fraction discharge tank 24. This bottom fraction discharge tank 24 has an outlet 24d connected to the intake of a pump P5, the delivery of which is connected, via a T-union 24a, on the one hand, to a further inlet 24e of the tank 24 and, on the other hand, to a discharge tap 24b.

Considering the boiler 20 again, this also has a steam outlet 20b, which is connected via a flexible pipe 25 to the condenser 21 which is designed to cool and condense the steam conveyed inside it. For this purpose, a cooling fan (not shown) is associated with the condenser 21.

The outlet 21a of the condenser 21 is connected to a flexible pipe 26 on which a T-union 27 and a control valve V3 are mounted. This flexible pipe 26 is connected to an inlet 22a of the top fraction discharge tank 22. The outlet 22b of the top fraction discharge tank 22 is connected via a pump P7 and a control valve V2 to a transfer inlet 20c of the boiler 20. Via the T-union 27 the outlet 21a of the condenser 21 is also connected to a flexible pipe 28 along which a carbon filter 29 is mounted. This flexible pipe 28 is connected to an inlet 23a of the distillate reserve tank 23. The outlet 23b of the distillate reserve tank 23 is connected to the intake of a pump P8, the delivery of which is connected to the mixing means of the device according to the invention.

These mixing means essentially comprise a mixing tank or reservoir 30. The delivery of the pump P8 is therefore connected to a supply inlet 30a of this mixing tank 30. A mixing outlet 30b of the mixing tank 30 is connected to a flexible pipe 31 along which a T-union 32 is mounted. The flexible pipe 31 is also connected to the intake of a pump P2, the delivery of which is connected to a mixing inlet 30c of the mixing tank 30. As can be seen in FIGS. 7a and 7b, the mixing tank 30 contains a breakwater member 33 which is situated opposite the mixing inlet 30c and is able to deflect radially the water which strikes it axially so as to increase aeration thereof. For this purpose, the breakwater member 33 has an apex 33a which is arranged centrally and is raised with respect to the remainder of the member 33 and from which a plurality of sockets 33b extend in radial fashion.

Salt supply means are also connected to the T-union 32 of the flexible pipe 31. These salt supply means essentially comprise a salt reserve tank or reservoir 40 and a metering valve VP1. This tank is able to contain a reserve of salts necessary for water which may be defined as drinking water in compliance with the existing regulations such as DPR No. 236/1988 and legislative decrees Nos. 31/2001 and 27/2002 and the EC directive 75/440. In particular, this tank contains a concentrated aqueous solution comprising a mixture of salts such as, for example, calcium, sodium or magnesium salts, oligoelements, etc., in the proportions permitted by the regulations. Alternatively, the salt reserve tank 40 may comprise a plurality of separate containers, each containing a specific salt in a concentrated solution. In this case, the device according to the invention also comprises a system for regulating the corresponding quantities of salts to be added to the water to be mineralized. Moreover, the device according to the invention may be advantageously designed to produce water with a personalized mixture of salts, for example for persons who must follow a hyposodic diet. The salt reserve tank may be replenished using sterile plastic bag refills.

The outlet 40a of the salt reserve tank 40 is connected to the intake of a pump P3, the delivery of which is connected to a T-union 41. A first outlet of this union 41 is connected to an inlet 40b of the salt reserve tank 40 and a second outlet is connected, via the metering valve VP1, to the T-union 32 upstream of the pump P2 of the mixing reservoir 30. The metering valve VP1 is able to be operated by the control unit of the device according to the invention so as to regulate the quantity of salts to be mixed in the distilled water which reaches the mixing tank 30. In order to detect the salinity level of the water, a conductivity sensor 45 is provided inside the mixing tank 30, said sensor being electrically connected to the control unit of the device according to the invention.

The mixing tank 30 also comprises a dispensing outlet 30d which is connected to dispensing means able to dispense a quantity of drinking water. These dispensing means comprise a pump P1, the delivery of which is connected to a dispensing tap 50. The tap 50 is arranged so as to allow filling of a container, for example a bottle B (visible in FIG. 1) with drinking water produced by the device.

Since filling and discharging of liquid into/from the tanks 10, 22, 23, 24, 30 and 40 results in a volumetric variation of the air contained in them and since the air in the environment where the device according to the invention operates may contain chemical substances and biological material not desirable in the water produced, a system for purifying the breathers of these tanks (shown in FIG. 6) is provided. In particular, the mixing tank 30, salt reserve tank 40 and distillate reserve tank 23 are connected to an active-carbon filter 60 and a filtration membrane (not shown) for removal of bacteria, viruses, etc. An electrical resistance device for burning off any fungal spores present in the air may be provided upstream of the carbon filter 60. The top fraction discharge tank 22 and the bottom fraction discharge tank 24 are connected to the filling tank 10. Moreover, the boiler 20 is connected to the filling tank 10 via a control valve V4. The breather of the filling tank 10 is connected directly to the external environment.

As can be seen in FIGS. 3 and 4, the tanks 10, 22, 23, 24, 30 and 40 have a parallelepiped form and may be positioned relative to each other by means of respective alignment projections 65 and recesses 66.

As already mentioned above, the valves and the sensors and generally the apparatus of the device according to the invention are controlled by a control unit (not shown). This control unit has a control panel 70 arranged on the cover 2 of the device and provided with a keyboard and a plurality of control lamps allowing a user to control operation of the device.

Operation of the device according to the invention will now be described in an embodiment which envisages connection of the device to a water supply network, with a filling inlet R and a discharge outlet S.

The water is supplied to the filling tank 10 via the valve V1 which opens and closes, controlled by the control unit, at the minimum and maximum levels.

Via the pump P4 and the pipe-clamp valve VP2, a predetermined quantity of water, for example 130 cl, passes from the filling tank 10 to the boiler 20 which will heat it to boiling temperature. The steam reaches the condenser 21 via the pipe 25 and, cooled to ambient temperature, reaches the initial discharge tank 22 via the valve V3 in the form of a first fraction of the quantity of distillate, for example 10 cl. This first condensate could contain substances more volatile than water such as: chlorine, hydrocarbons, alcohol, etc., and must therefore be discharged, for this reason, inside the top fraction discharge tank 22.

Once the predetermined quantity of the top fraction of the distillate collected inside the discharge tank 22 is reached, the valve V3 closes and the subsequent condensate, consisting of pure distilled water, is conveyed through the carbon filter 29 and then into the distillate reserve tank 23. The carbon filter 29 treats sterile water devoid of foreign agents and is therefore a redundancy component intended to eliminate any sporadic organic microelements conveyed in the steam flow and therefore has a very long working life. Its expiry is in any case signalled by an indicator lamp provided on the control panel 70.

When the quantity of water inside the boiler 20 falls below a predetermined minimum level, for example 20 cl, the control unit interrupts the heating process and the quantity of water contained inside the top fraction discharge tank 22 is transferred via the pump P7 and the valve V2 into the boiler 20 where it is mixed with the residual water which contains a high concentration of impurities. This mixing operation allows lowering of the temperature of the water contained inside the boiler 20 which is then conveyed via the valve VP3 and the pump P6 to the discharge outlet S.

The abovementioned operations are repeated until the distillate reserve tank 23, which has a relatively large capacity, for example about 5 l, is filled. The control unit activates transfer of a predetermined fraction of distilled water, for example 1 l, to the mixing tank 30 via the pump P8.

At this point a step involving mineralization of the water transferred to the mixing tank 30 is started. Once this mineralization step has been completed, the system does not allow mineralization of a further quantity of water until the water already mineralized is drawn off via the tap 50.

Via the keyboard of the panel 70 it is possible to adjust the required degree of mineralization (salinity). When this degree of mineralization is selected, a lamp lights up in order to indicate the start of the mineralization step during which the pump P2 remixes and increases aeration of the water contained inside the mixing tank 30 in conjunction with the breakwater member 33 installed inside this tank. The pump P3 instead remixes the concentrated solution of salts contained in the salt reserve tank 40 until the control unit activates supplying of the salts into the mixing tank 30 via the metering valve VP1.

The conductivity sensor 45 provides the control unit with a signal indicating the degree of salinity of the water inside the mixing tank 30. The control unit compares this value with the reference level entered and interrupts the mineralization procedure when the selected salinity value is reached. Operation of the valve VP1 by the control unit is performed in the manner now described. The control unit activates opening of the valve VP1 with pulses of gradually decreasing duration. The duration of the first opening pulse, namely the longer pulse, is adjusted by the control unit on the basis of the selected salinity value compared to the conductivity value of the distilled water. The gradual reduction of the duration of the successive pulses is performed in a predetermined and programmed manner so as to obtain fine adjustment of the salinity when close to the desired value. At the end of each opening pulse the control unit activates mixing of the water inside the mixing tank via the pump P2 and receives the signal supplied by the conductivity sensor. When the selected salinity value is reached, the control unit interrupts the sequence of opening pulses sent to the valve VP1.

At this point an indicator lamp on the control panel 70 signals the end of the mineralization operation. By means of the tap 50 it is possible to draw off the drinking water produced by the device according to the invention.

Operation of the device according to the invention in an embodiment which does not require connection of the device to a water network is now described.

The water to be treated is poured manually from a container into the filling reservoir 10 until it is full. The cycle which is then activated is identical to that described above, except for the fact that the top fraction waste products collected inside the top fraction discharge tank 22, once mixed with the bottom fraction waste products of the boiler 20, are stored inside the bottom fraction discharge tank 24, via the valve VP3, the pump P6 and the switching unit D set for discharging into the tank 24.

When the discharge tank 24 is full, the control unit activates a corresponding indicator lamp on the control panel 70 and sets the device to stand-by, preventing further cycles. Emptying of the tank 24 is performed by means of the tap 24b. The pump P5, in addition to conveying the waste products towards the tap 24b, remixes the contents of the tank 24 in order to keep the solid residues suspended, thus preventing them from being deposited on the bottom.

When the quantity of salts contained inside the reserve tank 40 has been used up, or when there is no more water inside the filling tank 10, the control unit activates a corresponding indicator lamp on the control panel 70 and sets the device to stand-by, preventing further cycles.

Without affecting the principle of the invention, the embodiments and the constructional details may be widely varied with respect to that described and illustrated purely by way of a non-limiting example, without thereby departing from the scope of protection of the present invention.

1. Device for producing drinking water, comprising supply means able to provide a quantity of inlet water, treatment means able to treat said quantity of inlet water so as to obtain a corresponding quantity of drinking water, and dispensing means able to dispense said quantity of drinking water, characterized in that said treatment means comprise:
distillation means able to distil said quantity of inlet water so as to obtain a corresponding quantity of distilled water;
salt supply means able to provide, in the form of a concentrated aqueous solution, at least one reserve of salts necessary for obtaining water which may be defined as drinking water; and
mixing means able to receive at least a part of said salt reserve and mix it in a controlled manner with said quantity of distilled water, at the same time aerating the latter, so as to provide said drinking water.

2. Device according to claim 2, also comprising control means able to control at least said distillation means, salt supply means and mixing means.

3. Device according to claim 1, in which the distillation means comprise a boiler to boil said quantity of inlet water so as to separate a distillate from a residue, a condenser able to cause condensation of said distillate, a top fraction discharge tank able to collect a top fraction of said distillate, and a distillate reserve tank able to collect said quantity of distilled water, said quantity of distilled water being formed by said distillate, without the top fraction.

4. Device according to claim 3, in which said top fraction discharge tank and said distillate reserve tank are connected to an outlet of said condenser via valve means which can be switched so as to connect selectively the condenser to said initial top fraction discharge tank or to said distillate reserve tank.

5. Device according to claim 3, in which said distillate reserve tank is connected upstream to a carbon filter.

6. Device according to claim 3, in which said top fraction discharge tank has an outlet connected to said boiler and designed to discharge said top fraction of the distillate inside it.

7. Device according to claim 6, in which said distillation means also comprise a bottom fraction discharge tank able to collect said residue from the boiler and said top fraction from the top fraction discharge tank.

8. Device according to claim 7, in which said boiler has a discharge outlet for elimination of said residue and said top fraction, which is connected to said bottom fraction discharge tank and to an external network via valve means which can be switched so as to connect selectively the discharge outlet of the boiler to said bottom fraction discharge tank or to said external network.

9. Device according to claim 3, in which said boiler is provided, internally, with a vane-type scraper apparatus designed to scrape inner surfaces of the boiler during boiling of the water.

10. Device according to claim 3, in which said salt supply means comprise a salt reserve tank which is able to contain said reserve of salts and one outlet of which is connected, via a metering valve, to said mixing means.

11. Device according to claim 10, in which said salt reserve is in the form of a concentrated aqueous solution comprising a mixture of salts.

12. Device according to claim 1, in which said salt reserve tank comprises a plurality of separate containers, each containing a specific salt in the form of a concentrated aqueous solution.

13. Device according to claim 11, in which the device is designed to produce water with a personalized mixture of salts.

14. Device according to claim 10, in which said mixing means comprise a mixing tank, an inlet of which is connected to said distillate reserve tank with which a pump is associated, the outlet of said metering valve being connected to the delivery of said pump, in order to mix said distilled water with said part of the salt reserve.

15. Device according to claim 14, in which the delivery of said pump is connected to a mixing inlet of the mixing tank which has installed inside it, opposite the mixing inlet, a breakwater member able to deflect radially the water axially striking it so as to increase aeration thereof.

16. Device according to claim 15, in which said breakwater member has an apex which is arranged centrally and is raised with respect to the remainder of said member and from which a plurality of sockets extend in radial fashion.

17. Device according to claim 14, in which the mixing tank has, arranged inside it, a conductivity sensor able to provide a signal indicating the degree of salinity of said distilled water mixed with said part of the salt reserve.

18. Device according to claim 17, in which said control means are designed to:
open said metering valve with a sequence of opening pulses of gradually decreasing duration, in which the duration of the first opening pulse is adjusted on the basis of a predetermined level entered compared to the conductivity value of the distilled water;
activate, at the end of each opening pulse, mixing of the water inside the mixing tank;
compare said signal indicating the degree of salinity with the predetermined level entered and interrupt the sequence of opening pulses when this level is reached.

19. Device according to claim 1, in which said supply means comprise a filling tank which has an inlet which can be connected to an external water network and an opening for manual filling.

20. Device according to claim 3, in which at least some of said tanks have breathers connected to an active-carbon filter.

21. Device according to claim 20, in which an electric resistance device for burning off any fungal spores present in the air is provided upstream of the carbon filter.

22. Device according to claim 3, in which said tanks have a parallelepiped form and can be positioned relative to each other by means of respective alignment projections and recesses.

23. Device according to claim 2, in which said device is housed inside a housing provided with a removable cover on which a panel for controlling said control means is arranged, said panel being provided with a keyboard and a plurality of control lamps.
